(19) United States
(12) Patent Application Publication
(10) Pub. No.: US 2004/0174236 A1
(43) Pub. Date: Sep. 9, 2004

(54) Ceramic RF filter having improved third harmonic response

(76) Inventor: Brian Richard Matthews, Albuquerque, NM (US)

Correspondence Address: Steven Weseman, CTS Wireless Components, 171 Covington Drive, Bloomingdale, IL, 60108, US

(21) Appl. No.: 10/080,338

(22) Filed: Feb. 21, 2002

(51) Int. Cl. H01P 1/20

(52) U.S. Cl. 333/206

(57) ABSTRACT

A duplexing communication signal filter has a prismoid dielectric core having three sets of paired opposed sides. The dielectric core defines at least one through-hole passageway between one set of the pair opposed side and a void in one of the paired sides other than the apertured opposed sides. Present on the core of dielectric material is a surface-layer pattern of metallized and unmetallized areas including a relatively expansive metallized region to provide a reference potential, an unmetallized region surrounding one or more of the apertures, a transmitter pad, a receiver pad spaced apart from the transmitter pad, an antenna pad positioned between the transmitter pad and the receiver pad, and a second unmetallized region on the void to provide an unmetallized void.

### TECHNICAL FIELD

This invention relates to dielectric block filters for radio-frequency signals, and in particular, to monoblock single pass-band and duplexing filters.

### BACKGROUND

Ceramic block filters offer several advantages over lumped component filters. The blocks are relatively easy to manufacture, rugged, and relatively compact. In the basic ceramic block filter design, the resonators are formed by typically cylindrical passages, called through-holes, extending through the block from the long narrow side to the opposite long narrow side. The block is substantially plated with a conductive material (i.e. metallized) on all but one of its six (outer) sides and on the inside walls formed by the resonator holes.

One of the two opposing sides containing through-hole openings is not fully metallized, but instead bears a metallization pattern designed to couple input and output signals through the series of resonators. This patterned side is conventionally labeled the top of the block, though the “top” designation may also be applied to the side opposite the surface mount contacts when referring to a filter in the board mounted orientation. In some designs, the pattern may extend to sides of the block, where input/output electrodes are formed.

The reactive coupling between adjacent resonators is affected, at least to some extent, by the physical dimensions of each resonator, by the orientation of each resonator with respect to the other resonators, and by aspects of the top surface metallization pattern. Interactions of the electromagnetic fields within and around the block are complex and difficult to predict.

These filters may also be equipped with an external metallic shield attached to and positioned across the open-circuited end of the block in order to cancel parasitic coupling between non-adjacent resonators and other components of the RF application device.

Although such RF signal filters have received widespread commercial acceptance since the 1980s, efforts at improvement on this basic design continued.

In the interest of allowing wireless communication providers to provide additional service, governments worldwide have allocated new higher RF frequencies for commercial use. To better exploit these newly allocated frequencies, standard setting organizations have adopted bandwidth specifications with compressed transmit and receive bands as well as individual channels. These trends are pushing the limits of filter technology to provide sufficient frequency selectivity and band isolation.

Coupled with the higher frequencies and crowded channels are the consumer market trends towards ever smaller wireless communication devices (e.g. handsets) and longer battery life. Combined, these trends place difficult constraints on the design of wireless components such as filters. Filter designers may not simply add more space-taking resonators or allow greater insertion loss in order to provide improved signal rejection.

A specific challenge in RF filter design is providing sufficient attenuation (or suppression) of signals that are outside the target passband at frequencies which are integer multiples of the frequencies within the passband. The label applied to such integer-multiple frequencies of the passband is “a harmonic.” Providing sufficient signal attenuation at the third (3^{rd}) harmonic has been a persistent challenge.

Therefore, it would be desirable to provide an RF filter that better attenuates 3^{rd} harmonic frequencies without sacrificing other performance parameters such as size, passband insertion loss and material costs.

### SUMMARY

This invention overcomes problems of the prior art by providing a ceramic block RF filter having improved 3^{rd} harmonic rejection in a small size.

An embodiment of this invention is a duplexing communication signal filter suitable for use in a mobile communication device and connection to an antenna, a transmitter and a receiver for filtering an incoming signal from the antenna to the receiver and for filtering an outgoing signal from the transmitter to the antenna. The filter comprises a prismoid dielectric core having three sets of paired opposed sides. The dielectric core defines at least one through-hole passageway between one set of the pair opposed sides. The through-hole passageways terminate in opposing apertures to provide a set of apertured opposed sides. The core also defines a void in one of the paired sides other than the apertured opposed sides.

Present on the core is a surface-layer pattern of metallized and unmetallized regions including a relatively expansive metallized region to provide a reference potential, an unmetallized region surrounding at least one of the apertures, a transmitter pad metallized region, a receiver pad metallized region spaced apart from the transmitter pad metallized region, an antenna pad metallized region positioned between the transmitter pad metallized region and the receiver pad metallized region and a second unmetallized region on the void to provide an unmetallized void.

The void is preferably elongate having a slot-like shape. When present on a parallelepiped-shaped core, the slot has an orientation such that the slot is perpendicular to the pair of opposed apertured surfaces and parallel to the edges at the interface of the side surfaces.

In an alternate embodiment of the present invention a signal filter having input and output electrodes is provided. Specifically the filter comprises a rigid core of dielectric material, preferably with a rectangular parallelepiped shape, and a surface-layer pattern of metallized and unmetallized regions supported by the core. The core has a top surface, bottom surface and at least four side surfaces. The core defines a series of through-holes, each extending from an opening on the top surface to an opening on the bottom surface. The core also defines a void on one of the four side surfaces. The surface-layer pattern of metallized and unmetallized regions includes an expansive region of metallization to absorb off-band signals, an unmetallized region substantially surrounding at least one opening, an unmetallized region on the void, an input connection region of metallization and an output connection region of metallization spaced apart from the input connection region.

There are other advantages and features of this invention which will be more readily apparent from the following detailed description of the preferred embodiment of the invention, the drawings, and the appended claims.

### BRIEF DESCRIPTION OF THE FIGURES

In the Figures,

FIG. 1 is an enlarged perspective (or more precisely an isometric) view of a duplexing filter according to the invention;

FIG. 2 is an enlarged perspective view of the filter of FIG. 1 showing details of an opposing side surface; and

FIG. 3 is an enlarged top side view of FIG. 1.

### DETAILED DESCRIPTION OF PREFERRED EMBODIMENTS

While this invention is susceptible to embodiment in many different forms, this specification and the accompanying drawings disclose only preferred forms as examples of the invention. The invention is not intended to be limited to the embodiments so described, however. The scope of the invention is identified in the appended claims.

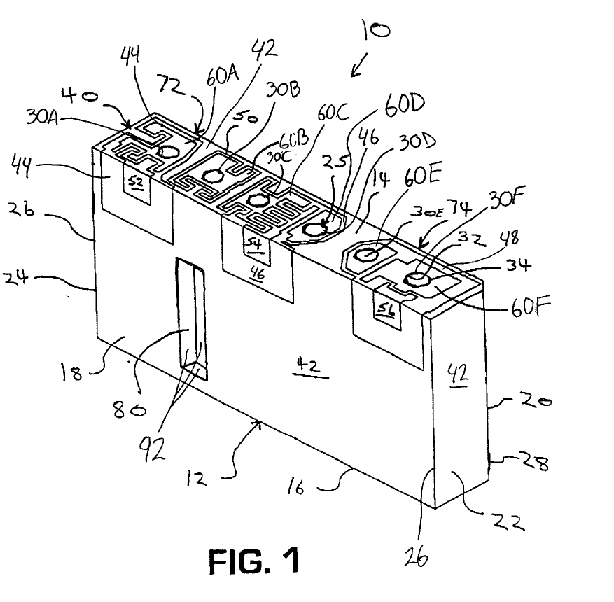

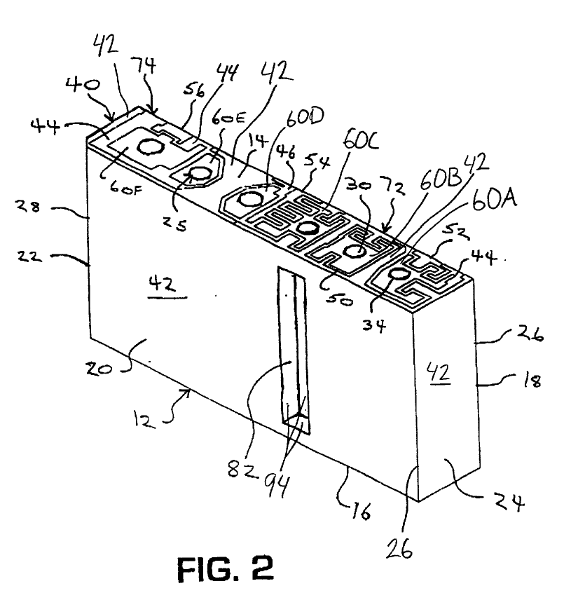

Referring to FIGS. 1, 2 and 3, an antenna duplexer or RF filter 10 includes an elongate, parallelepiped (or “box-shaped”) core of ceramic dielectric material 12. Core 12 has three sets of opposing side surfaces, a top 14 and a bottom 16, opposing long sides 18 and 20, and opposing narrow sides 22 and 24. The interface between sides 18, 20, 22 and 24 define parallel edges 26 and a bevel 28. Bevel 28 facilitates automated part placement during filter fabrication and subsequent application device assembly.

Core 12 defines a series of six through-hole passageways 30A through 30F, which extend from an aperture 34 on top side 14 to a bottom side 16 aperture (not separately shown). Core 12 also defines an elongated void 80 located in side surface 18. Void 80 is oriented parallel to edges 26 and perpendicular to top and bottom surfaces 14 and 16. Similarly, an elongated unmetallized void 82 is located in side surface 20. Slot 82 is aligned parallel to vertical edges 26 and perpendicular to top and bottom surfaces 14 and 16. When having the preferred elongate, substantially rectangular shape, voids 80 and 82 are conveniently labeled slots.

Core 12 is rigid and is preferably made of a ceramic material selected for mechanical strength, dielectric properties, plating compatibility, and cost. The ceramic material is preferably a fired, rigid barium-containing ceramic with a dielectric constant in the range of about 25 to about 87, but most preferably 37.5. The preparation of suitable dielectric ceramics is described in U.S. Pat. No. 6,107,227 to Jacquin et al. and U.S. Pat. No. 6,242,376, the disclosures of which are hereby incorporated by reference to the extent they are not inconsistent with the present teachings. Core 12 is preferably prepared by mixing separate constituents in particulate form (e.g., Al₂O₃, TiO₂, Zr₂O₃) with heating steps followed by press molding and then a firing step to react and inter-bond the separate constituents.

Filter 10 includes a pattern of metallized and unmetallized regions (or areas) 40. Pattern 40 includes an expansive, wide region of metallization 42, six unmetallized regions 44, 46, 48, 50, 92 and 94, a transmitter metallized connection pad 52, a receiver metallized connection pad 56, and an antenna metallized connection pad 54.

Expansive metallized region 42 covers portions of top surface 14 and side surface 18, and substantially all of bottom surface 16, side surfaces 20, 22, 24 and the sidewalls 32 of through holes 30. Expansive metallized region 42 extends contiguously from within the resonator holes 30 towards both top surface 14 and bottom surface 16. Region 42 serves as a local ground.

Core 12 and pattern 40 together form a series of through-hole resonators 25A, B, C, D, E and F. The portions of expansive metallized region 42 extending around openings 34 of through-holes 30 are can be labeled “resonator pads.” Filter 10 has six through-holes 30 and six corresponding resonator pads 60A, B, C, D, E and F.

Pattern 40 includes six unmetallized regions 44, 46, 48, 50, 92 and 94 present on portions of top surface 14 and side surface 18. Unmetallized region 44 substantially surrounds (or circumscribes) resonator pad 60A and transmitter connection region 52. Unmetallized region 46 substantially surrounds antenna connection region 54 and resonator pad 60C. Unmetallized area 48 substantially surrounds receiver electrode 56 and resonator pad 60F. Unmetallized area 50 substantially surrounds resonator pad 60B.

Pattern 40 also includes unmetallized region 92 at void 80 and unmetallized region 94 at void 82.

Duplex filter 10 can be divided at an antenna electrode 54 into two branches of resonators 25, a transmitter branch 72 and a receiver branch 74. Transmitter branch 72 extends between antenna electrode 54 and end 24, while receiver branch 74 extends in the opposite direction between antenna electrode 54 and end 22. Each branch includes a plurality of resonators 25 and a respective input/output electrode. More specifically, transmitter branch 72 includes a transmitter electrode 52, and receiver branch 74 includes a receiver electrode 56. Transmitter electrode 52 and receiver electrode 56 are spaced apart from antenna electrode in opposite directions along the length of core 12.

Antenna, transmit and receive metallized regions 54, 52 and 56 are defined by metallization pattern 40 and extend over portions of both top surface 14 and side surface 18. These electrodes extend onto side surface 18 where they serve as surface mounting connection points.

Pattern 40 includes metallized areas and unmetallized areas. The metallized areas are spaced apart from one another and, when filter 10 is in use, are capacitively coupled. The amount of capacitive coupling is roughly related to the size of the metallized regions, the separation distance between adjacent metallized regions, the overall core configuration, and the dielectric constant of the dielectric material. Similarly, pattern 40 also creates inductive coupling between the metallized areas. Interactions of the electromagnetic fields within and around core 12 are complex and difficult to predict.

The metallized areas of pattern 40 preferably comprise a coating of one or more layers of a conductive metal. A silver-bearing conductive layer is presently preferred. Suitable thick film silver-bearing conductive pastes are commercially available from The Dupont Company's Microcircuit Materials Division.

The surface-layer pattern of metallized and unmetallized areas 40 on core 12 may be prepared by providing a rigid core of dielectric material including through-holes to predetermined dimensions. The outer surfaces and through-hole sidewalls are coated with one or more metallic film layers by dipping, spraying or plating.

The pattern of metallized and unmetallized areas is then preferably completed by computer-automated laser ablation of designated areas on core 12. This laser ablation approach results in unmetallized areas which are not only free of metallization but also recessed into the surfaces of core 12 because laser ablation removes both the metal layer and a slight portion of the dielectric material.

Alternatively, selected surfaces of the fully metallized core precursor are removed by abrasive forces such as particle blasting resulting in one or more unmetallized surfaces. The pattern of metallized and unmetallized areas is then completed by pattern printing with thick film metallic paste.

Filters according to the present invention are optionally equipped with a metallic shield positioned across top surface 14. For a discussion of metal shield configurations, see U.S. Pat. No. 5,745,018 to Vangala. An important feature of the present invention is the side surface voids 80 and 82. Void 80 is preferably taken from long side surface 18 in transmitter branch 72. Most preferably, void 80 is taken from side surface 18 and aligned to a position between through-holes 30B and 30C. Void 82 is also preferably located in transmitter branch 72, and more preferably aligned between through-holes 30B and 30C. Specified by reference to the location of the surface mount pads, voids 80 and 82 are both preferably aligned to positions between the antenna connection pad 54 and the transmitter connection pad 52. The depth, width, and length of voids 80 and 82 can vary.

Voids 80 and 82 can be formed by grinding, laser ablation, or machining the core 12 to remove a portion of expansive metallized region 42 and a portion of core 12. Voids 80 or 82 can also be formed as a molded-in feature during the molding of ceramic material making up core 12. For a molded-in void, a mask is placed over the void space during the metal coating process.

Filter voids 80 and 82 preferably have a depth in the range of about 3percent to about 10 percent, and more preferably about 4 percent to about 7 percent, based on the thickness of the filter in the direction of the void. Referring to voids 80 and 82, the thickness of filter 10 is a measure of the distance between side 18 and side 20.

Preferred filters according to the present invention exhibit a passband for the outgoing (i.e. transmit) signal from about 1920 MHz to about 1980 MHz with a maximum insertion loss of at most 1.5 decibels (dB) and a 5760 MHz S₂₁ attenuation of at least 10 decibels (dB), more preferably a 5760 MHz S₂₁ attenuation of 14 decibels (dB). Preferred filters according to the invention also preferably exhibit a passband for the incoming (i.e. receive) signal from about 2110 MHz to about 2170 MHz with a maximum insertion loss of at most about 2.0 decibels (dB).

### STUDY EXAMPLES

A group of ten filters were prepared according to the embodiment shown in FIGS. 1 through 3, and as specified in Table I, below.

TABLE I

| | |
|---|---|
| Filter length (side 24 to side 22) | 9.80 mm |
| Filter board height (side 18 to 20) | 1.85 mm |
| Filter width (side 14 to side 16) | 5.30 mm |
| Through-hole 30 | 762 microns (μm) |
| diameter (uniform) | |
| Core dielectric constant | 37.5 |
| Outgoing (transmit) | 1920 to 1980 MHz |
| signal passband | |
| Incoming (receive) | 2110 to 2170 MHz |
| signal passband | |
| Side 20 void distance | 0.40 mm |
| from bottom surface 16 | |
| SM side 18 void distance | 0.25 mm |
| from bottom surface 16 | |

These example filters featured one or more elongate voids of varying position, depth, length and width. Presented in Table II, below, are the filter fabrication parameters that were varied for the comparison study.

TABLE II

| Exam- | | | | | Second | | | | | | | |
|---|---|---|---|---|---|---|---|---|---|---|---|---|
| ple | First Void Position (μm) | | | | Void Position (μm) | | | | Third Void Position (μm) | | | |
| Number | P | D | W | L | P | D | W | L | P | D | W | L |
| 1 | A | 46 | 432 | 4445 | | | | | | | | |
| 2 | B | 83 | 584 | 4470 | | | | | | | | |
| 3 | C | 67 | 787 | 4521 | | | | | | | | |
| 4 | D | 95 | 610 | 4470 | | | | | | | | |
| 5 | E | 61 | 457 | 4445 | | | | | | | | |
| 6 | C_{IO} | 69 | 610 | 3302 | | | | | | | | |
| 7 | B | 43 | 432 | 4318 | C | 43 | 559 | 4318 | | | | |
| 8 | C | 91 | 635 | 4587 | D | 58 | 559 | 4470 | | | | |
| 9 | C | 132 | 864 | 4496 | C_{IO} | 71 | 584 | 3327 | | | | |
| 10 | C | 76 | 737 | 4420 | D | 46 | 597 | 4394 | C_{IO} | 30 | 571 | 3556 |

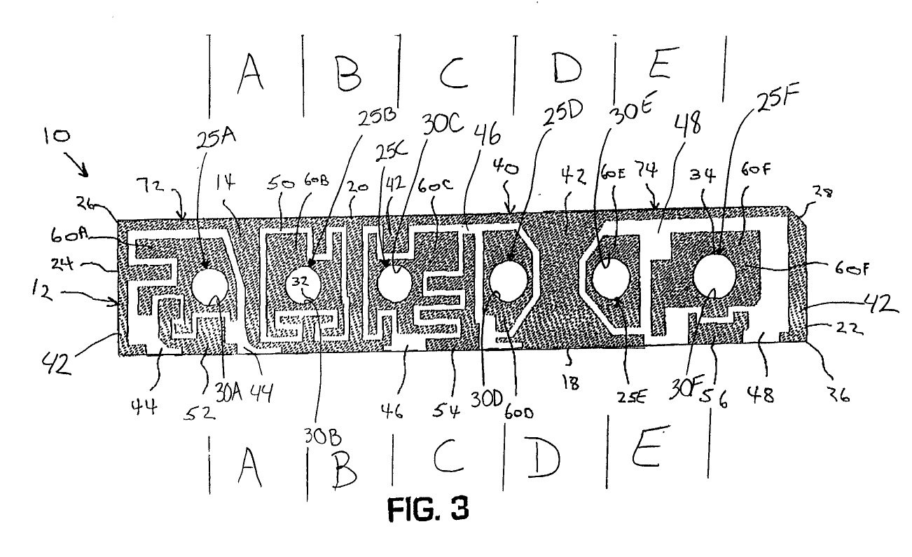

In Table II, column label P is a reference to the relative position of the void along the length of the filter 10. Position markers A, B, C, D and E showing the possible length-wise alignment of the voids are provided in FIG. 3. The position marker subscript IO indicates that the void space was taken from the surface mount side of the filter. Column labels D, L and W are a reference to the void depth, length and width, respectively.

Example filters 1 through 5 included a single unmetallized void on side 20, i.e. the side opposite the surface mount regions 54, 52 and receiver 56. Example filter 6 included a single void on the surface mount side 18, i.e. the I/O side. Example filters 7 and 8 each included two separate voids on side 20. Example filter 9 included a void on side 20 and a void on surface mount side 18. Example filter 10 included three voids, two on side 20 and one on surface mount side 18. The example filters were evaluated by measuring the type 21 Scattering Parameter using a network analyzer. Scattering Parameters were defined and related testing methods were developed to address the complexity of measuring and comparing electric devices for high frequency applications. S-parameters are ratios of reflected and transmitted traveling waves measured at specified component connection points. An S₂₁ data point or plot is a measure of insertion loss, a ratio of an output signal at an output connection to an input signal at an input connection, at one or a range of input signal frequencies.

For a discussion of Scattering Parameters and associated test standards and equipment, please consult the following references: Anderson, Richard W. “S-Parameter Techniques for Faster, More Accurate Network Design,” Hewlett-Packard Journal, vol. 18, no. 6, Feb. 1967; Weinert, “Scattering Parameters Speed Design of High Frequency Transistor Circuits,” Electronics, vol. 39, no. 18, Sep. 5, 1986; or Bodway, “Twoport Power Flow Analysis Using Generalized Scattering Parameters,”Microwave Joumal, vol. 10, no. 6, May 1967.

More specifically, each example filter was evaluated by first fabricating a duplexing filter without voids having the passbands specified in Table I. The filter without voids was then tested to obtain an S₂₁ plot. Selected S₂₁ data points were recorded and are presented in TABLE III, below, under the row heading “ctrl.” After control testing, one or more unmetallized voids were added by laser ablation to the tested filter as specified in TABLE II.

The void-added example filters were then retested to obtain a second S₂₁ plot. S₂₁ data were recorded and are presented in TABLE III, below, next to the corresponding control measurements.

TABLE III

| | Transmit | Receive | | | |
|---|---|---|---|---|---|
| | Maximum | Maximum | Attenuation | Attenuation | Attenuation |
| Example | Insert. Loss | Insert. Loss | @ 3960 MHz | @ 5760 MHz | @ 5940 MHz |
| No. | (dB) | (dB) | (dB) | (dB) | (dB) |
| 1 ctrl | 1.2 | 1.6 | 34.9 | 5.9 | 7.2 |
| | 1.2 | 1.6 | 32.2 | 5.3 | 8.3 |
| 2 ctrl | 1.3 | 1.67 | 34.6 | 6.5 | 8.2 |
| | 1.3 | 1.67 | 35.5 | 7.8 | 7.6 |
| 3 ctrl | 1.13 | 1.74 | 34.8 | 5.6 | 6.1 |
| | 1.4 | 1.75 | 37.5 | 8.6 | 3.2 |
| 4 ctrl | 1.25 | 1.89 | 34.2 | 6.7 | 7.7 |
| | 1.23 | 1.99 | 37.5 | 16.9 | 7.9 |
| 5 ctrl | 1.1 | 1.76 | 34.5 | 6.8 | 7.6 |
| | 1.1 | 2.0 | 33.6 | 9.6 | 8.7 |
| 6 ctrl | 1.16 | 1.68 | 35.3 | 6.9 | 7 |
| | 1.27 | 1.69 | 35.2 | 10.8 | 5 |
| 7 ctrl | 1.2 | 1.64 | 35.6 | 6 | 6.1 |
| | 1.3 | 1.6 | 37.1 | 6.9 | 3.6 |
| 8 ctrl | 1.3 | 1.64 | 34.3 | 5.0 | 7.5 |
| | 1.37 | 1.65 | 37 | 19 | 4.6 |
| 9 ctrl | 1.1 | 1.66 | 34.8 | 6.4 | 4.9 |
| | 1.24 | 1.67 | 37 | 14.4 | 11 |
| 10 ctrl | 1.14 | 1.68 | 35.4 | 6.8 | 7.8 |
| | 1.34 | 1.69 | 38.3 | 22.5 | 9.4 |

S₂₁ data were recorded for the maximum insertion loss over the transmit passband (1920-2980 MHz), the maximum insertion loss over the receive passband (2110-2170 MHz), two times the high end of the transmit passband (3960 MHz), three times the low end of the transmit passband (5760 MHz) and three times the high end of the transmit passband (5940 MHz).

Example 9 was identified as the preferred embodiment. Example 9 exhibited a significant improvement in attenuation at the harmonic target frequencies and only minor additional signal losses in the transmit and receive passbands. A specification for Example 9 is presented below in TABLE IV.

TABLE IV

| | |
|---|---|
| Filter length | 9.80 mm |
| Filter height | 1.85 mm |
| Filter width | 5.30 mm |
| Through-hole 30 | 762 microns (μm) |
| diameter (uniform) | |
| Core dielectric constant | 37.5 |
| Outgoing (transmit) | 1920 to 1980 MHz |
| signal passband | |
| Incoming (receive) | 2110 to 2170 MHz |
| signal passband | |
| Void 82 distance | 0.40 mm |
| from bottom surface 16 | |
| Void 82 length | 4.50 mm |
| Void 82 width | 0.86 mm |
| Void 82 depth | 0.13 mm |
| Void 80 distance | 0.25 mm |
| from bottom surface 16 | |
| Void 80 width | 0.58 mm |
| Void 80 length | 3.33 mm |
| Void 80 depth | 0.07 mm |

Numerous variations and modifications of the embodiments described above may be effected without departing from the spirit and scope of the novel features of the invention. It is to be understood that no limitations with respect to the specific system illustrated herein are intended or should be inferred. It is, of course, intended to cover by the appended claims all such modifications as fall within the scope of the claims.

I claim:

1. A duplexing communication signal filter adapted for connection to an antenna, a transmitter and a receiver, the filter for filtering an incoming signal from the antenna to the receiver and for filtering an outgoing signal from the transmitter to the antenna, the filter comprising:
a prismoid dielectric core having three sets of paired opposed sides, the core defining at least one through-hole passageway between one set of the pair opposed sides and terminating in opposing apertures to provide a set of apertured opposed sides, and a void in one of the paired sides other than the apertured opposed sides;
a surface-layer pattern of metallized and unmetallized regions on the core including,
a relatively expansive metallized region to provide a reference potential,
an unmetallized region surrounding at least one of the apertures;
a transmitter pad metallized region,
a receiver pad metallized region spaced apart from the transmitter pad metallized region,
an antenna pad metallized region positioned between the transmitter pad metallized region and the receiver pad metallized region,
a second unmetallized region on the void to provide an unmetallized void.

2. The filter of claim 1 wherein the unmetallized void is elongate and oriented perpendicular to the set of apertured opposed sides.

3. The filter of claim 1 wherein the unmetallized void is spaced between the antenna pad and the transmitter pad over a length of the prismoid core.

4. The filter of claim 1 wherein a second unmetallized void is present in a side opposite the side having the first void.

5. The filter of claim 4 wherein the second unmetallized slot is located between the antenna pad and the transmitter pad.

6. The filter of claim 1 wherein the unmetallized region surrounds the transmitter pad metallized region.

7. The filter of claim 1 wherein the core defines a plurality of through-hole passageways, each through-hole passageway terminates in an aperture on the apertured opposed sides, and the unmetallized region circumscribes each aperture.

8. The filter of claim 1 wherein the unmetallized region circumscribes the receiver pad metallized region.

9. The filter according to claim 1 exhibiting a filtering passband for the outgoing signal from about 1920 MHz to about 1980 MHz and exhibiting filtering passband for the incoming signal from about 2110 MHz to about 2170 MHz.

10. The filter according to claim 1 exhibiting a filtering passband for the outgoing signal from about 1920 MHz to about 1980 MHz and an S21 attenuation of at least about 10 decibels (dB) at about 5760 MHz.

11. A signal filter suitable for use in a mobile communication device, the filter comprising:
a core of dielectric material having a top, a bottom and four side surfaces having side surface interface edges;
a plurality of through holes extending from the top to the bottom surface, each through-hole defining a resonator;
an unmetallized region located on the top surface and extending to one of the side surfaces;
a relatively expansive metallized region located on the bottom surface, the side surfaces and on the inner surfaces of the throughholes;
an isolated transmitter electrode, an isolated antenna electrode and an isolated receiver electrode, each located on the top surface and extending to one of the side surfaces;
an elongate unmetallized slot disposed on at least one of the side surfaces in an orientation parallel to the interface and extending between the top and bottom surfaces.

12. The filter of claim 11 wherein the slot has a depth in the range of about 3 percent to about 10 percent based on the thickness of the filter.

13. The filter of claim 11 wherein the depth of the slot is in the range of about 4 percent to about 7 percent.

14. The filter of claim 11 wherein the slot is located between the antenna electrode and the transmitter electrode.

15. The filter of claim 11 further comprising a second slot located on another side surface.

16. The filter of claim 15 wherein the second slot is located between the antenna electrode and the transmitter electrode.

17. The antenna duplexer of claim 11 wherein the unmetallized region is recessed into the core.

18. The antenna duplexer of claim 11 wherein the core is molded and the slot is a molded feature of the core.

19. The antenna duplexer of claim 11 exhibiting a filtering passband for the outgoing signal from about 1920 MHz to about 1980 MHz and an S21 attenuation of at least about 10 decibels (dB) at about 5760 MHz.

20. An antenna duplexer comprising:
a prismoid dielectric core having three sets of paired opposed sides;
an antenna connection electrode on the elongate ceramic block;
a transmitter branch extending between the antenna electrode and a first end of the block;
a receiver branch extending between the antenna electrode and a second end of the block, the second end opposing the first end;
each branch having a plurality of through-hole resonators extending between opposing apertures on one set of the paired opposed sides to provide a set of apertured opposed sides;
a transmitter connection electrode spaced apart from the antenna electrode along a length of the block and positioned in the transmitter branch;
a receiver connection electrode spaced apart from the antenna electrode along a length of the block and positioned in the receiver branch;
a relatively expansive metallized region for providing a reference potential; and
a void in one of the paired sides other than the apertured opposed sides.

21. The antenna duplexer of claim 20 wherein the void is located in the transmitter branch.

22. The antenna duplexer of claim 20 wherein the transmitter branch includes a through-hole adjacent the antenna connection electrode and the void is located between the first end and the adjacent through-hole.

23. The antenna duplexer of claim 20 wherein the transmitter branch includes a first and a second through-hole extending in a series from the antenna connection electrode towards the first end, and the void is located between the first and second through-holes.

24. The duplexing communication filter according to claim 20 wherein the core has a substantially rectangular parallelepiped shape.

25. The duplexing filter according to claim 20 wherein the core defines six through-holes.

26. The duplexing filter according to claim 20 exhibiting a transmit signal passband from about 1920 to about 1980 Megahertz (MHz) and a maximum insertion loss over the passband of at most about 1.5 dB.

27. A communication signal filter comprising:
a prismoid dielectric core having three sets of paired opposed sides, the core defining at least one through-hole passageway between one set of the pair opposed sides and terminating in opposing apertures to provide a set of apertured opposed sides, and a void in one of the paired sides other than the apertured opposed sides;
a surface-layer pattern of metallized and unmetallized regions on the core including,
a relatively expansive metallized region to provide a reference potential,
an unmetallized region surrounding at least one of the apertures;
an input pad metallized region,
an output pad metallized region spaced apart from the input pad metallized region,
a second unmetallized region on the void to provide an unmetallized void.
